(19) United States
(12) Patent Application Publication
(10) Pub. No.: US 2022/0366485 A1
(43) Pub. Date: Nov. 17, 2022

(54) SYSTEM AND PROCESS FOR OBTAINING AND SELECTING CONTRACTOR BIDS FOR A BUILDING-SPECIFIC REPAIR PROJECT

(71) Applicant: Jerold Saeman, Hastings, MI (US)

(72) Inventor: Jerold Saeman, Hastings, MI (US)

(21) Appl. No.: 17/739,746

(22) Filed: May 9, 2022

Related U.S. Application Data
(60) Provisional application No. 63/186,918, filed on May 11, 2021.

(51) Int. Cl. G06Q 30/08; G06Q 30/00; G06Q 30/06; G06Q 10/00; G06V 20/10

(52) U.S. Cl. CPC G06Q 30/08; G06Q 30/012; G06Q 30/0633; G06Q 10/20; G06V 20/176

(57) ABSTRACT

A method for obtaining a bid for repairing a roof of a building structure using a portable computing device includes obtaining information about the building structure using aerial photographs and exterior photographs of the building structure to define a work site and selecting at least a portion of the work site to define a scope of repair within the work site. The method also includes obtaining an event report related to the scope of repair and combining the scope of repair and the event report to define warranty parameters. The method also includes communicating the scope of repair and the warranty parameters to a contractor bidding interface. The method also includes receiving the bids from at least one bidding contractor and selecting a desired contractor from the at least one bidding contractor, via the contractor bidding interface and selecting payment terms for paying the desired contractor.

### CROSS-REFERENCE TO RELATED APPLICATION

This application claims priority to and the benefit under 35 U.S.C. § 119(e) of U.S. Provisional Patent Application No. 63/186,918, filed on May 11, 2021, entitled SYSTEM AND PROCESS FOR OBTAINING AND SELECTING CONTRACTOR BIDS FOR A BUILDING-SPECIFIC REPAIR PROJECT, the entire disclosure of which is hereby incorporated herein by reference.

### FIELD OF THE DISCLOSURE

The system and method are in the field of on-line programs and smart device applications, and more specifically, on-line programs and smart device applications that are used for defining the parameters of a building-specific repair project and obtaining bids related to the building-specific repair project via a wireless computing network.

### SUMMARY OF THE DISCLOSURE

According to a first aspect of the present disclosure, a method for obtaining a bid for repairing a roof of a building structure includes obtaining, via a portable computing device, information about the building structure using aerial photographs and exterior photographs of the building structure to define a work site. The method also includes selecting, via the portable computing device, at least a portion of the work site to define a scope of repair within the work site. The method also includes obtaining, via the portable computing device, an event report related to the scope of repair. The method also includes combining, via the portable computing device, the scope of repair and the event report to define warranty parameters. The method also includes communicating, via the portable computing device, the scope of repair and the warranty parameters to a contractor bidding interface. The method also includes receiving the bids from at least one bidding contractor via the contractor bidding interface. The method also includes selecting, via the portable computing device, a desired contractor from the at least one bidding contractor, via the contractor bidding interface and selecting payment terms for paying the desired contractor.

According to another aspect of the present disclosure, a method for obtaining a bid for repairing a portion of a building structure includes obtaining, via a portable computing device, information about the building structure using aerial photographs and exterior photographs. The method also includes combining the aerial photographs and the exterior photographs to define a three-dimensional model of the building structure. The method also includes selecting, via the portable computing device, at least a portion of the three-dimensional model to define a scope of repair related to the building structure. The method also includes obtaining, via the portable computing device, an event report related to the scope of repair. The method also includes combining, via the portable computing device, the scope of repair and the event report to define warranty parameters. The method also includes selecting building materials to define a materials list. The method also includes combining the scope of repair, the materials list and the warranty parameters to define an estimated material cost. The method also includes communicating, via the portable computing device, the scope of repair, the materials list and the estimated material cost to a contractor bidding interface. The method also includes receiving the bids from at least one bidding contractor via the contractor bidding interface. The method also includes selecting, via the portable computing device, a desired contractor from the at least one bidding contractor, via the contractor bidding interface.

According to another aspect of the present disclosure, a method for obtaining a bid for repairing a roof of a building structure includes generating a three-dimensional model of the building structure using aerial photographs and exterior photographs of the building structure. The method also includes selecting at least a portion of the three-dimensional model to define a scope of repair that corresponds to the building structure. The method also includes selecting a list of materials that relate to the scope of repair. The method also includes combining the scope of repair and the list of materials to define a project estimate. The method also includes communicating the scope of repair, the list of materials and the project estimate to a contractor bidding interface. The method also includes receiving the bids from at least one bidding contractor via the contractor bidding interface. The method also includes selecting, via a portable computing device, a desired contractor from the at least one bidding contractor, via the contractor bidding interface. The method also includes communicating information related to the desired contractor to a plurality of financial institutions to obtain a plurality of financing offers. The method also includes selecting a preferred financing offer of the plurality of financing offers.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a perspective view of an exemplary smart device that can be used for performing an aspect of a system and method described herein for obtaining and selecting a contractor bid for a building-specific repair project;

FIG. 2 is an exemplary aerial view that can be utilized for assessing and obtaining dimensional information regarding the building to assess a scope of the building-specific repair project;

FIG. 3 is an exemplary exterior photo of a structure that can be utilized for assessing and obtaining the dimensional characteristics of a structure for determining the scope of repair for the building-specific repair project;

FIG. 4 is a diagram exemplifying meteorological information relating to hail storms and other weather-related events;

FIG. 5 is a schematic flow diagram illustrating a method for forming a three-dimensional model of the structure for determining the scope of repair for a repair project;

FIG. 6 is a schematic flow diagram illustrating a method for using material data and the three-dimensional model for determining the scope of repair for a repair project;

FIG. 7 is a schematic diagram illustrating the formation of the scope of repair;

FIG. 8 is a schematic diagram illustrating an aspect of the contractor bidding interface;

FIG. 9 is a schematic diagram illustrating an aspect of the communications hub;

FIG. 10 is a linear flow diagram illustrating a method for obtaining a bid for repairing a roof of a building structure utilizing an aspect of the building repair program and the contractor bidding interface;

FIG. 11 is a schematic flow diagram illustrating a method for obtaining a bid for repairing a portion of the building structure utilizing an aspect of the building repair program and the contractor bidding interface;

FIG. 12 is a schematic flow diagram illustrating a method for obtaining a bid for repairing a roof of a building structure utilizing an aspect of the building repair program and the contractor bidding interface;

FIG. 13 is a schematic linear flow diagram illustrating a method for communicating an insurance claim to an insurance agent utilizing an aspect of the building repair program;

FIG. 14 is a schematic linear flow diagram illustrating a method for selecting a desired contractor utilizing an aspect of the contractor bidding interface; and

FIG. 15 is a schematic linear flow diagram illustrating a method for utilizing the building repair program for assisting construction material suppliers and construction material manufacturers to purchase materials in response to contractor bids placed in a particular geographic area.

### DETAILED DESCRIPTION OF THE PREFERRED EMBODIMENTS

As required, detailed embodiments of the present disclosure are disclosed herein; however, it is to be understood that the disclosed embodiments are merely exemplary of the invention that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present invention.

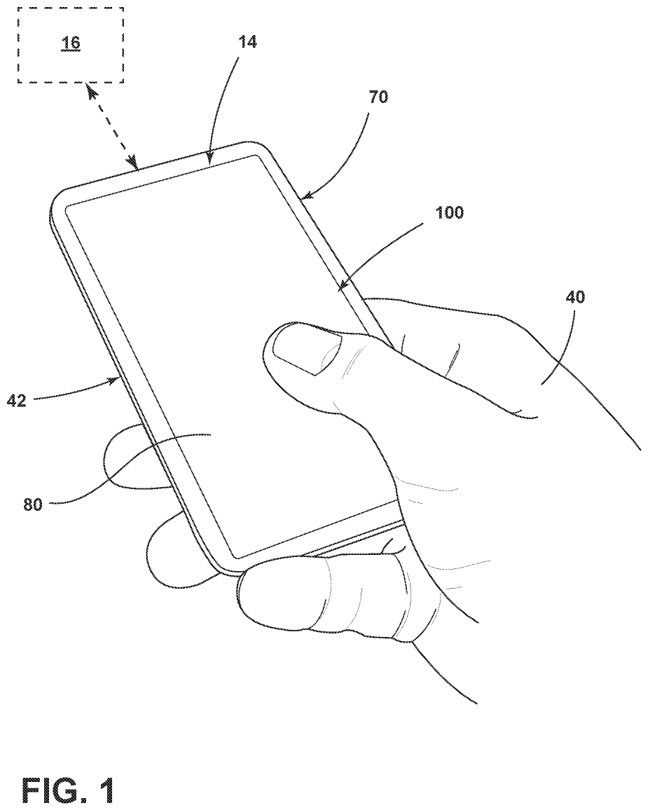

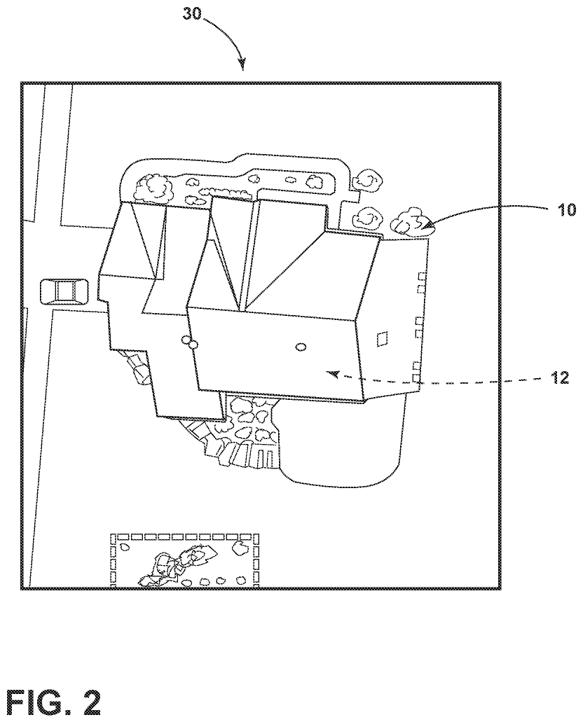

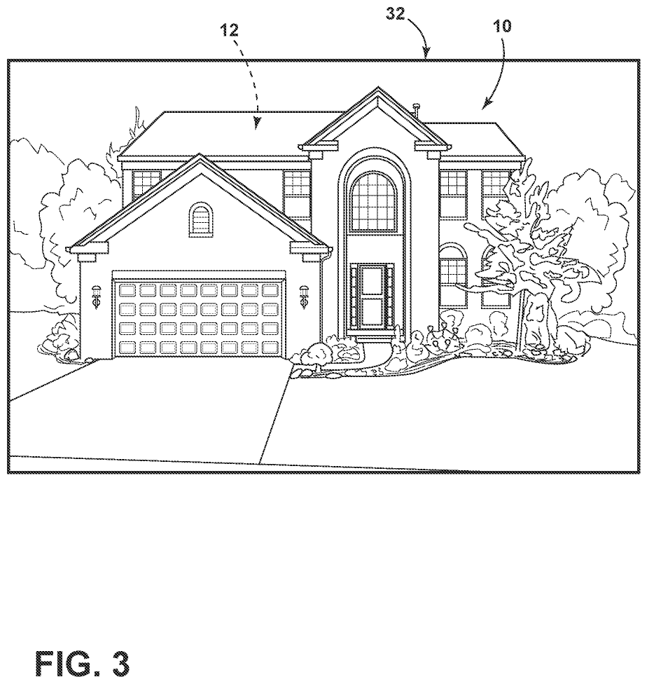

For purposes of description herein, the terms “upper,” “lower,” “right,” “left,” “rear,” “front,” “vertical,” “horizontal,” and derivatives thereof shall relate to the concepts as oriented in FIGS. 1-3. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a smart device application for determining a scope of a repair project and developing a repair team and communicating with that repair team throughout the repair project. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

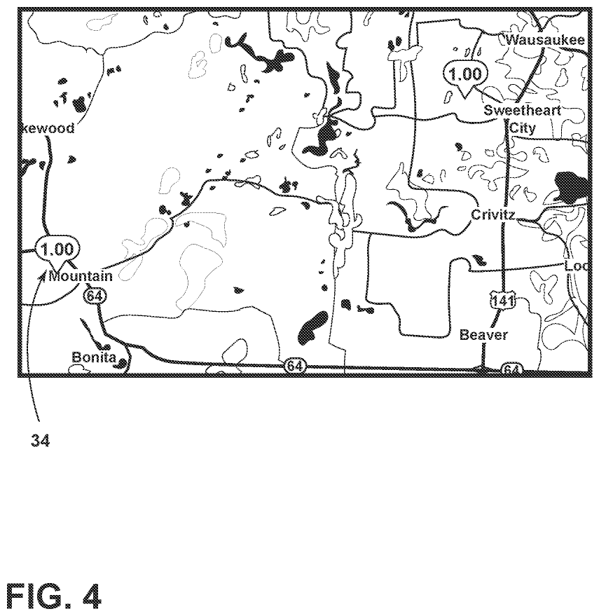

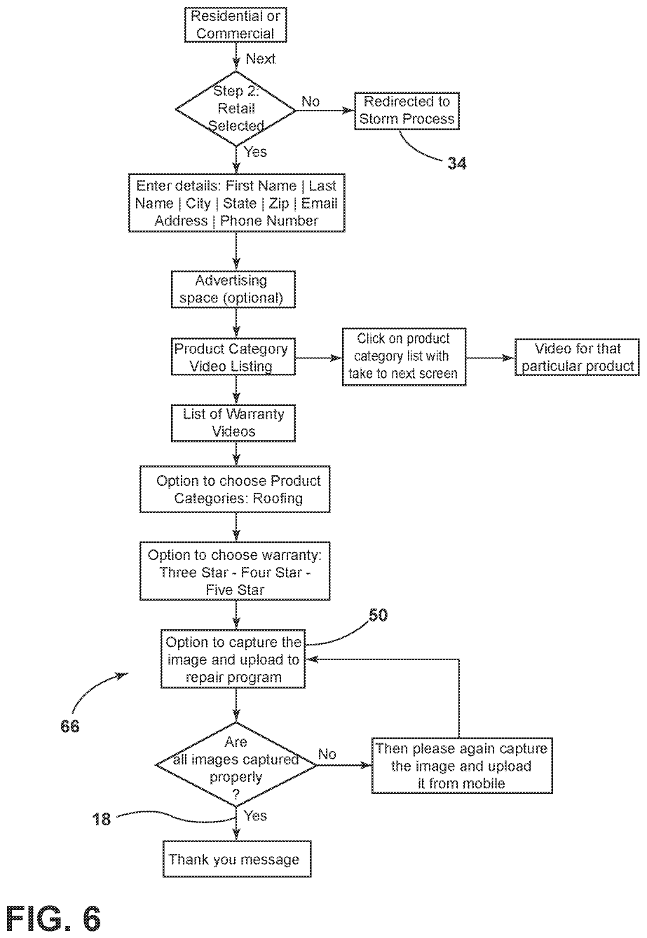

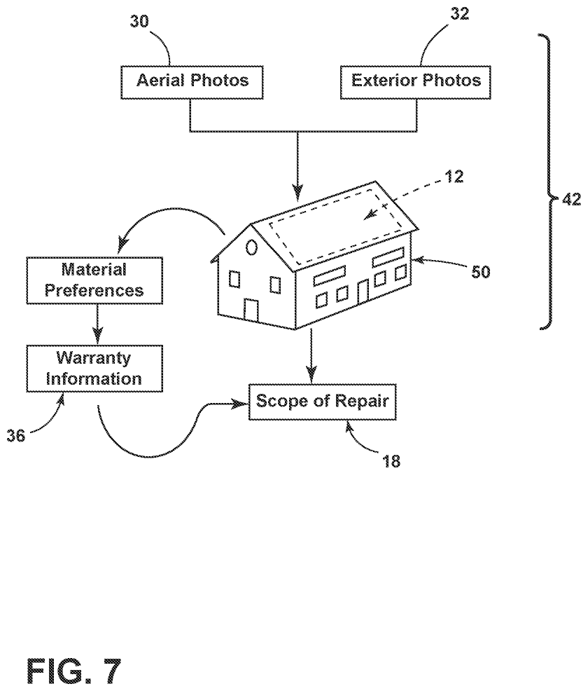

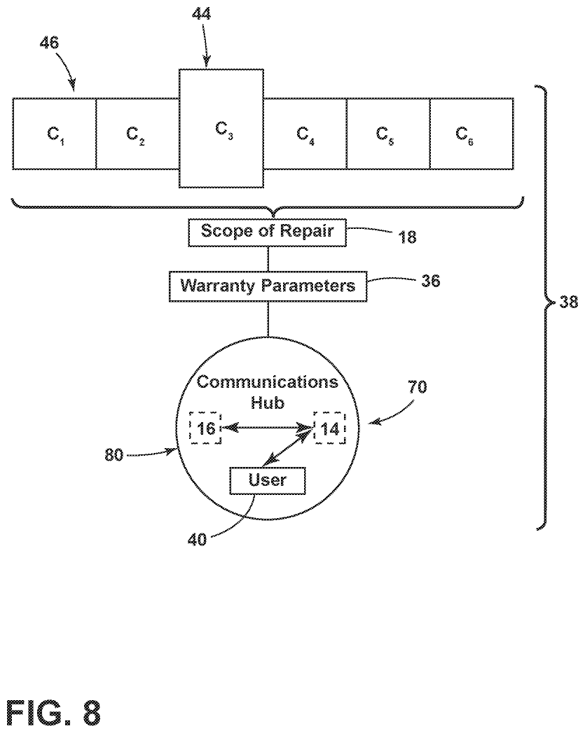

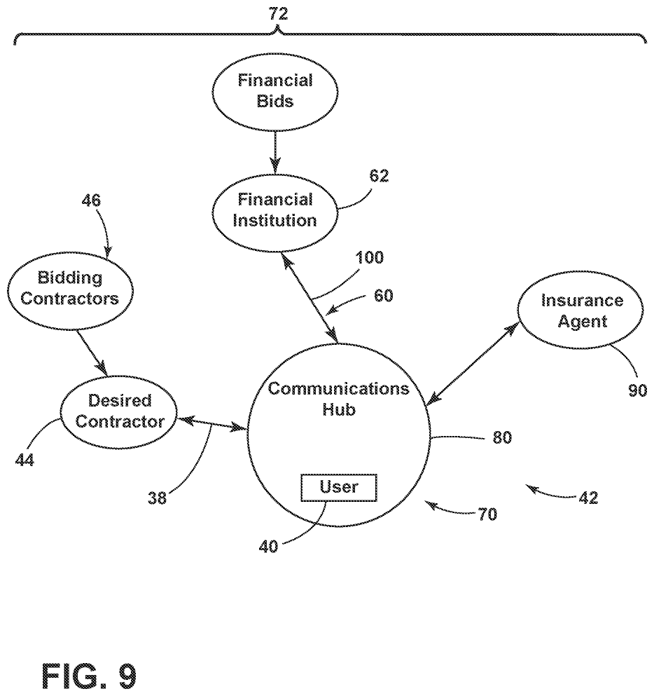

Referring to FIGS. 1-9, reference numeral 10 generally refers to a structure for which a certain repair project 12 is to be completed. The repair project 12 can be in the form of a roof repair, siding repair, window repair and replacement, gutter repair and replacement, gutter installation, or other similar construction-related project for repairing or improving the relevant structure 10. The system and method described herein utilizes a portable computing device having a processor, such as a smart device 14, and a wireless computing network 16 for determining the scope of repair 18 for the building-specific repair project 12, obtaining pricing and financing for the repair project 12, and obtaining competitive bids from bidding contractors 46 that can be selected to define a desired contractor 44 for completing the repair project 12.

According to various aspects of the device, the system and method for obtaining the bid for completing a building-specific repair project 12 utilizes aerial photographs 30 and exterior photographs 32 of the structure 10 to define a scope of repair 18. The method also includes obtaining historical meteorological information 34 to define warranty parameters 36. These warranty parameters 36 can be in the form of warranty information that may be related to building materials attached to the structure 10, the types of building materials that may be needed for a particular climate or location, the type of damage that may have occurred to the structure 10, the cause of the damage and other similar factors. The system and method also includes a step of communicating, via a communications hub 70 and selection interface 80, the scope of repair 18 and the warranty parameters 36 to a contractor bidding interface 38. This contractor bidding interface 38 can include, but is not limited to, a computer program, smart device application or other similar processor-operated program that utilizes a portable computing device or other smart device 14 and a wireless computing network 16.

After the scope of repair 18 and the warranty parameters 36 are communicated to the contractor bidding interface 38, the user 40 of the system and method, herein after referred to as the building repair program 42, can select a desired contractor 44 via the contractor bidding interface 38. Using the contractor bidding interface 38, it is typical that at least one bidding contractor 46, and typically a plurality of bidding contractors 46, will provide a competitive bid or estimated price for completing the scope of repair 18. Once the user 40 obtains bidding information from one or more bidding contractors 46, the user 40 can select the desired contractor 44 having the preferred bid via the selection interface 80 and the contractor bidding interface 38. This selection of the desired contractor 44 can be based on one or more of a plurality of parameters that are included within the building repair program 42. The selection of the desired contractor 44 can also be based on one or more of a plurality of parameters that are important to the user 40. These parameters can include, but are not limited to, price, availability, timing, familiarity with the bidding contractor 46, and other similar objective and subjective criteria. It is contemplated that these objective and subjective criteria can be ranked or scored according to their respective importance to the user 40. Accordingly, the user 40 can develop a customizable prioritization routine for finding the most preferred contractors and ultimately finding the desired contractor 44 or desired contractors 44.

After the desired contractor 44 is selected, the user 40 can select payment terms 60 for paying the desired contractor 44 to complete the scope of repair 18. These payment terms 60 can include contacting one or more separate financial institutions 62 to obtain financing offers, typically a plurality of financing offers. From these plurality of financing offers, the user 40 can select a preferred financing offer for obtaining the financing to pay for the cost of the scope of repair 18. In addition, the payment terms 60 can include a negotiation with the desired contractor 44. These negotiations can be based on overall price, quality of materials, estimated completion dates, and other various criteria that can be important to the user 40 and/or the desired contractor 44.

Referring again to FIGS. 1-9, the system and method described herein can be utilized for remotely obtaining a bid from the bidding contractors 46 to select a desired contractor 44 for a scope of repair 18 without leaving the individual's property or meeting with the bidding contractors 46 in person. The system and method can also be used for hiring a desired contractor 44 in an expedient fashion. This expediency is particularly relevant where the scope of repair 18 includes repairs to a portion of the building envelope for the structure 10 or other critical area of the structure 10.

Referring again to FIGS. 1-9, the system and method for the building repair program 42 collects relevant data for defining a scope of repair 18, warranty parameters 36, and other information concerning the building-specific repair project 12. Using this information, the user 40 interacts with selection interface 80 of the smart device 14 to perform the various steps and processes of the building repair program 42, as described herein. In this manner, the building repair program 42 incorporates a communications hub 70 for providing direct communications between the user 40 and one or more bidding contractors 46 and the desired contractor 44, between the user 40 and one or more financial institutions 62, and between the user 40 and an insurance agent 90, and other communications pathways. Communications with the insurance agent 90 can be used for assessing and determining the warranty parameters 36 of the building-specific repair project 12. Collectively, these participants assisting the user 40 in completing the building-specific repair project 12 can be referred to as the repair team 72. Typically, the user 40 will manage the communications hub 70 so that communication between members of the repair team 72 are delivered or uploaded via the communications hub 70 and are therefore made known to the user 40 for record keeping and verification of the process of the building-specific repair project 12. Using the communications hub 70, the user 40 is able to communicate with the repair team 72 throughout the construction process of the building-specific repair project 12 and also monitor the communications between members of the repair team 72.

Referring again to FIGS. 1-9, various algorithms are included within the building repair program 42 for coordinating the various operations of the repair team 72 for completing the building-specific repair project 12. These algorithms are used at various points in performance of the building repair program 42 for completing the building-specific repair project 12. These algorithms are used to assist the user 40 and the repair team 72 in defining the scope of repair 18, the warranty parameters 36, the payment parameters and other functions related to the program and the building-specific repair project 12.

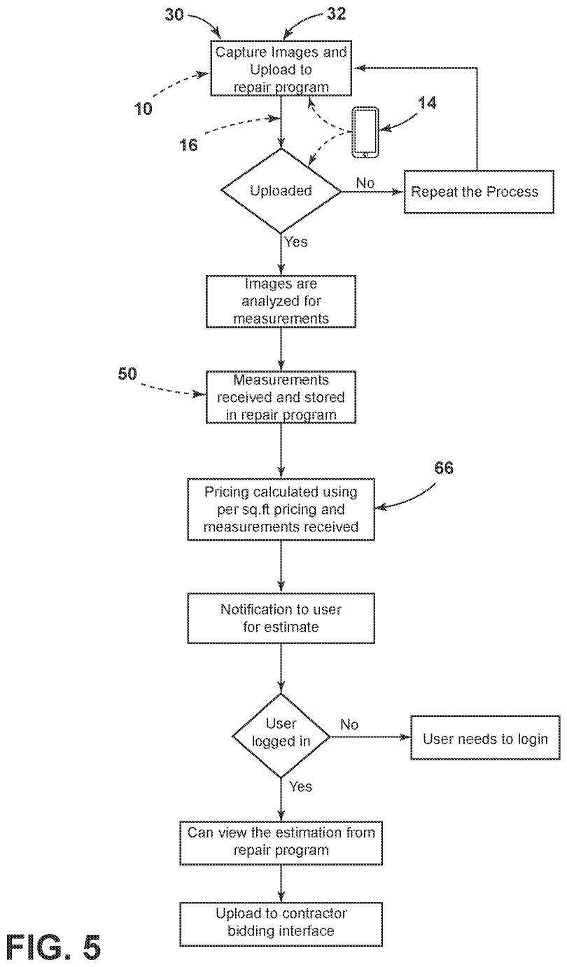

Referring now to FIGS. 5-9, the building repair program 42 can include a digital or electronic bid form that includes a multi-step process that can be utilized for gathering information related to the building-specific repair project 12. This multi-step process can include an auto-save feature at each step so that a user 40 can include certain information, attend to an interruption, and then return to the step of the multi-step process where they left off. According to the steps of the various processes and algorithms included herein, it is contemplated that these steps may not appear in the order specified, and can be rearranged and reordered depending upon the particular building-specific repair project 12.

Within the initial steps of the building repair program 42, a user 40 may be required to select, via a selection interface 80, whether the building is a residential structure 10 or a commercial structure 10. Along with this selection, certain indicating or status information can be obtained such as name, address, contact information, and other similar information related to the user 40 and the structure 10 that is to be repaired. In addition to obtaining information, a user 40 can be provided with certain business-related information related to products, services, and other opportunities related to the building repair program 42. Certain advertising information and advertising space can be provided along the periphery or within the selection interface 80. This visible space that appears within the selection interface 80 can be utilized by related companies for promoting related goods and services, as well as ancillary goods and services and wholly unrelated goods and services. This business-related information and advertisements can be provided at various points in the building repair program 42 and may be turned off by the user 40 if not desired.

Referring again to FIGS. 1-9, after the indicating and status information has been obtained from the user 40 that is related to the user 40, the structure 10 and the building-specific repair project 12, a user 40 can begin setting and defining the scope of repair 18 for the particular project. The user 40 can also set and define the warranty parameters 36 related to the building-specific repair project 12. In particular, using the selection interface 80, a user 40 can describe the portion of the structure 10 that is to be repaired. After the type of repair is selected, a user 40 can describe the materials they would prefer to be used in the repair project 12. These selections can include material type, product color, material styles, warranty information, cost information and other similar information related to the products and services used for the building-specific repair project 12. These parameters can be combined to derive an estimated material cost. This estimated material cost is typically provided to all of the bidding contractors 46. By providing the same estimated material cost to all of the bidding contractors 46, the building repair program 42 and the contractor bidding interface 38 can be used to provide a user 40 with comparable bids that are based upon as much commonly available information as possible. In this manner, the user 40 can efficiently evaluate a number of bidding contractors 46.

In certain aspects of the device, the user 40 can select a material option that allows the bidding contractor 46 to include a material cost within the respective bids. In such an aspect of the device, the user 40 can require a particular grade or quality of materials be included within each bid. In addition, it is contemplated that the user 40 can request or require documentation of material prices and selections to ensure that the bid of each bidding contractor 46 includes the same minimum qualifying information and details. This option can also be used by a bidding contractor 46 to bid on multiple projects within a particular area. This can allow bidding contractors 46 to purchase materials in bulk for the completion of multiple projects having a similar scope and similar needs for materials, as is described more fully herein.

When selecting a particular product, various options and supplemental information can be included with respect to material quality as well as the various warranties associated with a particular material. The portion of the selection interface 80 related to the building materials can provide a comparison of various product warranty options that the user 40 may be interested in using for the building-specific repair project 12. These comparisons can include numerous details related to the coverage provided as well as the costs associated with each warranty option. This information can be conveyed through videos, charts, graphs, text and other similar audio-visual media. The selection interface 80 provides the user 40 with warranty information relating to the various levels and types of warranties as well as cost and timeframe information related to each. This information allows the user 40 to make an informed decision concerning the type of product warranty that they would like with respect to the products being used for the building-specific repair project 12. After the selected building materials are determined, these selected building materials can be compiled into a materials list. This materials list can be incorporated into the scope of repair 18 and a project estimate that can be delivered or uploaded to the contractor bidding interface 38.

Throughout this disclosure related to the system and method for completing a building-specific repair project 12, roofing and roofing repairs are being described herein. It should be understood that other portions of the interior of the structure 10 and the exterior of the structure 10 can be incorporated within the building repair program 42 for describing and identifying the building-specific repair project 12.

Referring again to FIGS. 1-9, it is contemplated that a building-specific repair project 12 may be needed after a storm, accident or other unforeseen event. In the case of a storm, the selection interface 80 can be used to communicate with an insurance agent 90 via the communications hub 70. In this manner, the user 40 can directly contact the insurance agent 90 for the user's home insurance provider so that a claim can be made using the selection interface 80 and the smart device 14 for implementing the building repair program 42. The communications hub 70 for the building repair program 42 allows for a communication interface between the user 40 and an insurance agent 90 for making or filing an insurance claim and obtaining insurance information that can be used for paying for the cost of the building-specific repair project 12.

As part of this insurance information, historic meteorological information 34 can be used for verifying the approximate time, path and location of certain weather events, such as hail storms, thunderstorms, tornadoes and other similar weather events that may cause damage to a structure 10. A third-party program such as Hail Strike, HailTrace, Hail-Reports, Hail Recon® and other similar meteorological websites can be used in conjunction with the building repair program 42 for gathering and processing meteorological information 34. A processor within the communications hub 70 or within the smart device 14 can gather this data and provide a comparison of weather events and the date the structure 10 experienced damage for determining whether any particular damage is covered under the home warranty. The building repair program 42 can be used cooperatively with these programs for obtaining metrological information that can assist the user 40 and the insurance agent 90 in processing the insurance claim related to the structure 10 to be repaired. Using the location (address, GPS location, latitude and longitude and other identifiers) of the structure 10 in combination with GPS information or geographic data from the gathered meteorological information 34, data can be compared to verify the location of the meteorological event in relation to the structure 10 and damage to the structure 10.

In addition, where a weather event, accident, or other damage-causing event occurs, the user 40 can be asked to provide information concerning the present condition of the structure 10. Such information can include whether there is a leak in the structure 10, whether the structure 10 includes structural damage that is visible from the outside, and other similar information related to the condition of the structure 10.

Where an accident occurs, the smart device 14 and the communications hub 70 can be used to gather information related to incident or event reports, such a police reports, utilities reports, fire reports and other similar event-related reports that are directed to the damage of the structure 10.

To assess the warranty parameters 36 of the building-specific repair project 12, the age of the building products currently on the structure, and other information concerning the selected building materials and the existing warranty information related to the selected building materials can be assessed. The assessment of insurance information, warranty information and other similar information can be used to determine the sources of funding for completing the building-specific repair project 12, as is described more fully herein.

In each of the steps related to verifying information, providing initials or signatures, or other similar declarative statements, various verification programs such as DocuSign® (as a non-limiting example) can be used for attesting or verifying certain information or for agreeing to the terms and/or conditions of various steps of the process for completing the building-specific repair project 12.

As part of determining the scope of work, the dimensions of the area to be repaired is verified using images captured by the user 40 of the outside of the structure 10 and relevant portions of the inside of the structure 10. These images can be provided through the use of various aerial photographs 30 and exterior photographs 32 provided by the user 40. The various aerial photographs 30 and exterior photographs 32 can also be captured and/or provided through coordination with certain third-party websites (such as Hover® as a non-limiting example). The captured images of the structure 10 are used to estimate or determine the dimensions and surface area of the structure 10 and more specifically, the area to be repaired through the repair project 12. In this manner, the aerial photographs 30 and exterior photographs 32 are used to define a work site that can include portions of the building structure 10 as well as areas surrounding the building structure 10. Using the building repair program 42 in combination with various third party websites, digital images of the elevations of the structure 10 and aerial views of the structure 10 can be converted into a three-dimensional model 50 of the structure 10. Using this three-dimensional model 50, dimensional information related to the surface area of the structure 10 can be extrapolated using the communications hub 70 and/or the smart device 14. In this manner, the three-dimensional model 50 can be prepared for determining the scope of repair 18. This information can be used during the bidding process to determine the amount of building materials that may be needed, the approximate time to complete the repair project 12, and other information related to the scope of repair 18. Using these images, the three-dimensional model 50 or framework of the structure 10 can be developed for accurately determining the area involved in the scope of repair 18. It is contemplated that information related to the structure 10 can be stored by the user 40, in a cloud-computing setting, within a memory of the portable computing device, or other similar location for later reference or later use.

In certain aspects of the device, the three-dimensional model 50 can be generated using supplemental or alternative image-capturing methods and mechanisms. These image-capturing methods and mechanisms can include, but are not limited to, radar, lasers, LIDAR, augmented reality systems, manual measurements, combinations thereof and other similar image-capturing strategies.

During the formulation of the scope of repair 18, the digital images captured by the user 40 and/or third party mapping sites, various estimates can be calculated using this dimensional information. Accordingly, the building repair program 42 can include an estimation tool 66 that utilizes the dimensional information in conjunction with the materials selected by the user 40, various installation and/or material packages that can be graded based upon quality (good, better, best). The material packages that can be selected can include selections that incorporate materials typically used for common repairs. By way of example, and not limitation, the material packages can include shingles, underlayment, flashing, drip edges and bituminous materials, and other materials commonly included within the repair. The selection of the material packages can provide for materials of a common grade and can also provide for an ala carte selection of materials or substitution of individual materials within a material package.

The building repair program 42 can also provide a selection interface 80 that the user can operate to include contractor preferences within the contractor bidding interface 38. This contractor-preference information can include various criteria that the user may find helpful in selecting a contractor. As a non-limiting example, this criteria can be related to information about contractors, such as whether the contractor is minority-owned or veteran-owned, or whether the contractor has a certain level or area of experience, as well as other similar permissible criteria. Using these and other parameters, the estimation tool 66 provides an approximate cost of the repair 18, or a range of costs where multiple options are sought by the user 40 for comparison. The estimation tool 66 provides a consistent bidding estimate that a number of contractors can use. Because the bidding contractors 46 are provided with the same information, the bids provided to the users 40 by the bidding contractors 46 can be efficiently evaluated.

Referring again to FIGS. 1-9, once the scope of repair 18 and warranty parameters 36 have been determined, information can be provided to a contractor bidding interface 38. Using the contractor bidding interface 38, the information is uploaded by the user 40 so the bidding contractors 46 can review and potentially bid on the building-specific repair project 12, as defined by the scope of repair 18 and warranty parameters 36. The warranty parameters 36 can be useful in determining a bid price, as certain insurance claims and warranty work can include specific conditions related to the repair or replacement of materials within the building-specific repair project 12.

When the information is uploaded to the contractor bidding interface 38, one or more bidding contractors 46 can provide proposed bids that the user 40 can review and compare against one another. The contractor bidding interface 38 can be included within the building repair program 42 or can be provided through a third party website for managing contractor bids for various projects. One such contractor bidding interface 38 is Acculynx®, as a non-limiting example. The contractor bidding interface 38 can store various information related to number of bids, the bid with the highest price and the bid with the lowest price, history of previous contactor bids, the amount of contractor bids that have been selected or rejected in the past and other statistical information related to contractors that use the contractor bidding interface 38.

It is contemplated that the contractor bidding interface 38 can be incorporated within the building repair program 42. It is also contemplated that the contractor bidding interface 38 can be included within the websites of participating contractors and tradesmen. Where the websites of the contractors and tradesmen incorporate the contractor bidding interface 38, it is contemplated that the building repair program 42 can directly or indirectly access the contractor bidding interface 38 through the portable computing device of the user as well as through the websites of the participating contractors and tradesmen.

The estimation tool 66 that is included in the building repair program 42 for determining the scope of repair 18 and the warranty parameters 36 can also include an option to decide whether financing will also be utilized, warranty information, whether the user 40 will pay immediately and other similar financial criteria.

According to various aspects of the device, certain preferences of the user 40, such as contractor sorting parameters, can be provided and stored for use with the contractor bidding interface 38. These contractor sorting parameters can be used to allow a user 40 to find and sort the provided bids. Using the contractor sorting parameters, the user 40 can identify the most preferred bids submitted for the building-specific repair project 12. The estimation tool 66 for the building repair program 42 can account for this information and can cooperate with the contractor bidding interface 38 for providing a relevance score of the user's preferred criteria. This relevance score can be used to assist the user 40 in selecting a desired contractor 44 for the building-specific repair project 12. This scoring can be in the form of a percentage match, a number of matched criteria and other similar scoring methods and mechanisms.

Using the contractor bidding interface 38, a user 40 can select the desired contractor 44 that they feel is the best bid provided through the contractor bidding interface 38. When the desired contractor 44 is selected, the verification tools described herein can be utilized for entering into agreements and signing various contractual engagements.

In situations where the building-specific repair project 12 will require financing, the building repair program 42 can cooperate with various third party sites to obtain financing for the building-specific repair project 12. Certain financial institutions 62 can be included. These financial institutions 62 can be conventional institutions as well as internet-based institutions such as GreenSky®, Rocket Loans®, SoFi®, and other similar conventional and on-line financial institutions 62. Similar to the contractor bidding interface 38, the building repair program 42 can include a financial interface 100 that can be used to competitively bid various financing options that can be available to the user 40 to complete the building-specific repair project 12, as is described more fully herein.

As the user 40 moves through the various prompts and algorithms of the building repair program 42, the user 40 can be notified about which steps of the process have be completed and which need to be yet completed. In addition, it is contemplated that various changes can be made to the scope of repair 18 and/or the warranty parameters 36 during the process of obtaining bids and/or financing. Changes in interest rates, changes in warranty information, and other similar information that may change or become known during the process of completing the building-specific repair project 12 can be incorporated within the program information to adjust the building-specific repair project 12 and the parameters therefor. In addition, preference-type decisions can be changed at a later date depending upon the preferences of the user 40. By way of example, and not limitation, the quality of materials can be modified at a later date. Any change in these parameters typically results in a prompt given to the user 40 that these changes may result in a change order for the contractor's bid, an addendum or other similar change to the desired bid for the scope of repair 18.

It is contemplated that the program can communicate with the user 40 during performance and after completion of the building-specific repair project 12. Information such as project completion date, issues discovered over the course of work, and other similar information can be communicated to the user 40 via the communications hub 70 of the building repair program 42. These communications are typically stored within the building repair program 42 for later reference. By storing these communications, miscommunications can be minimized during the completion of the building-specific repair project 12.

Utilizing the building repair program 42, the user 40 can obtain and upload information relating to the structure 10, bids, review and select a desired contractor 44, engage the desired contractor 44, obtain financing, interact with an insurance agent 90 and interact with a desired contractor 44, all with a portable computing device. The portable computing device that is able to implement and operate the building repair program 42 can include, but is not limited to, a smart device 14, tablet, mobile phone, home computer, wearable computing device, or other similar portable computing device. This can be done remotely from the comfort of a user's home, or any remote location. Accordingly, the user 40 can utilize the program for communicating with the desired contractor 44 in real time when the desired contractor 44 is not able to be onsite.

In many cases, frustrations can mount during construction projects when the desired contractor 44 is difficult to contact or is only intermittently available. Using the building repair program 42, the user 40 can conveniently contact the desired contractor 44 related to the building-specific repair project 12.

In addition to communications and interactions between the user 40 and desired contractor 44, the building repair program 42 can also be used by construction material suppliers and construction material manufacturers and other sources of building products. These construction material suppliers and construction material manufacturers can use information from the building repair program 42 related to certain projects that are bid out using the building repair program 42. Utilizing this information, the construction material suppliers and construction material manufacturers receive information that allows them to plan for current and future sales, production and manufacturing needs to keep up with demand during minimal or prolific periods of construction. Construction material manufacturers can slow operations during downturns in the market to avoid unnecessary surplus and potential waste of resources. In addition, using the historic meteorological data can direct the operations of the construction material suppliers and construction material manufacturers toward locations that may have the higher level of repairs such as those areas that have experienced a weather event such as a hurricane, hail storm, tornado or other similar event that typically results in damage to one structure 10 or, more typically, a large number of structures 10.

Utilizing the building repair program 42, various bidding contractors 46 throughout a large geographic area can be permitted to bid on certain projects. This can provide for an efficient and convenient mobilization of resources to be directed to a particular area of the country. By way of example, and not limitation, if a hail storm strikes a portion of the Midwest, bidding contractors 46 in various parts of the country within the Midwest and outside the Midwest can plan their mobilization efforts to maximize their resources in an area that may be hundreds of miles away from their home office. This building repair program 42 provides increased competition to benefit users 40 of the building repair program 42 and more bid opportunities that can assist bidding contractors 46 that use the building repair program 42. In addition, the bidding contractors 46 can bid on a large number of projects within a particular area at one time. Using the building repair program 42, the user 40 can be informed where a particular bidding contractor 46 or group of bidding contractors 46 are working or will be working in a particular area. Where weather-related events occur, it is typical for a large number of structures 10 to have similar types of damage and have a similar scope of work for the repair 18. This information can allow the user 40 to utilize a contractor that is already mobilized or preparing to mobilize to a particular geographic area. As discussed herein building material suppliers and building material manufacturers are able to access the information related to accepted bids and the number of repair projects 12 that have been assigned to one or more desired contractors 44.

The process of completing a building-specific repair project 12 can be streamlined by bringing together various resources to a single interface for the user 40 to review, interact with, select from, and utilize for completion of the particular project.

As described herein, the program is utilized for the performance and completion of building-specific repair projects 12. It is also contemplated that the program can be utilized with new construction, building additions, interior renovations, and other similar construction projects.

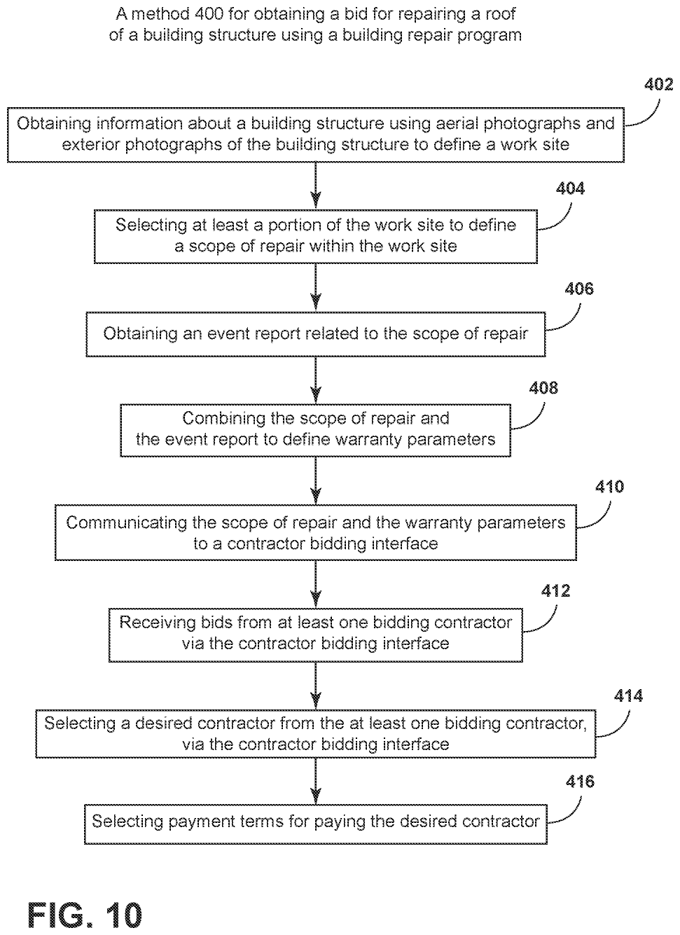

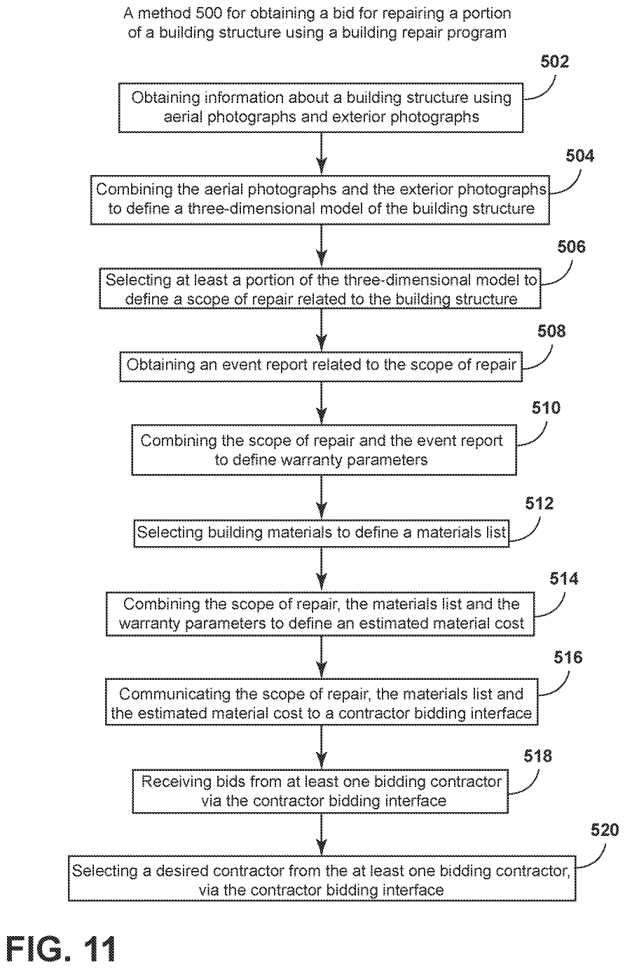

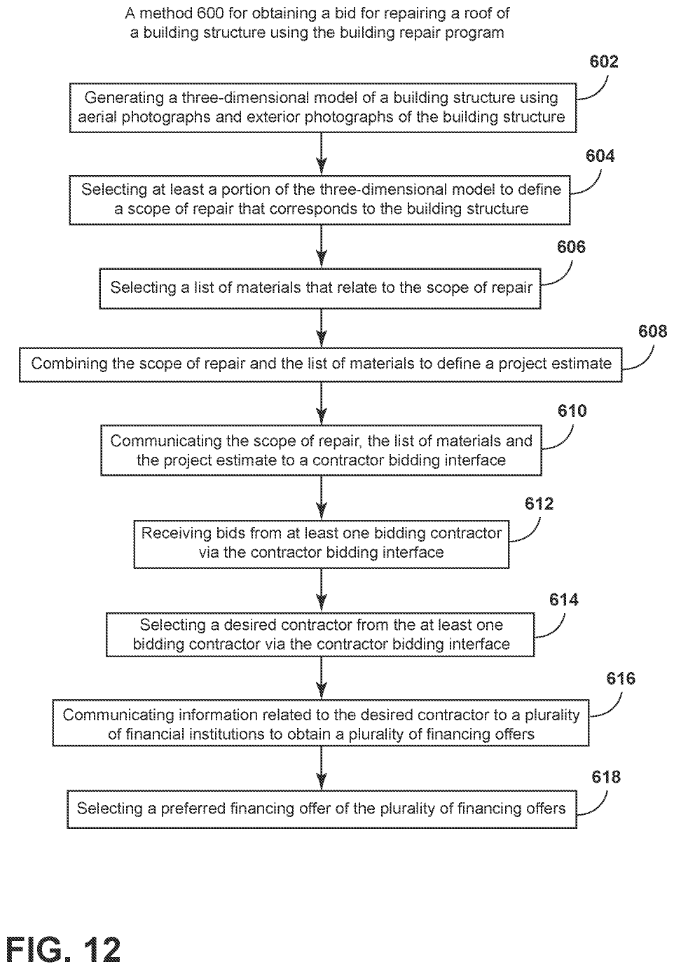

Referring now to FIGS. 1-15, various methods are shown and described herein. It is contemplated that the steps of these methods described herein are accomplished using portable computing devices that are utilized by the user 40, contractors, insurance agents 90, financial institutions 62, construction material suppliers, construction material manufacturers, and other parties within the construction industry for accessing and utilizing the building repair program 42 and the contractor bidding interface 38.

Referring now to FIGS. 1-10, having described various aspects of the building repair program 42 and the contractor bidding interface 38, a method 400 is disclosed for obtaining a bid for repairing a roof of a building structure 10 utilizing an aspect of the building repair program 42 and the contractor bidding interface 38. According to the method 400, step 402 includes obtaining information about a building structure 10 using aerial photographs 30 and exterior photographs 32 of the building structure 10 to define a work site. A step 404 includes selecting at least a portion of the work site to define a scope of repair 18 within a work site. Step 406 includes obtaining an event report related to the scope of repair 18. Typically, this event report can be in the form of a meteorological report, incident report, police report, or other similar document related to the building structure 10 and repair 18 that needs to be made. Step 408 of method 400 includes combining the scope of repair 18 and the event report to define warranty parameters 36. Step 410 includes communicating the scope of repair 18 and the warranty parameters 36 to a contractor bidding interface 38. Step 412 includes receiving bids from at least one bidding contractor 46 via the contractor bidding interface 38. According to the method 400, step 414 includes selecting a desired contractor 44 from the at least one bidding contractor 46 utilizing the contractor bidding interface 38. Step 416 of the method 400 includes selecting payment terms 60 for paying the desired contractor 44. These payment terms 60 can include payments made by an insurer or under a product warranty, payments made through a financial institution 62, payments made directly by the user 40, combinations thereof and other similar payments.

Referring now to FIGS. 1-9 and 11, having described various aspects of the device, a method 500 is disclosed for obtaining a bid for repairing a portion of the building structure 10 utilizing the building repair program 42 and the contractor bidding interface 38. According to the method 500, step 502 includes obtaining information about a building structure 10 using aerial photographs 30 and exterior photographs 32. Step 504 includes combining these photographs to define a three-dimensional model 50 of the building structure 10. Step 506 of method 500 includes selecting at least a portion of the three-dimensional model 50 to define a scope of repair 18 related to the building structure 10. Step 508 includes obtaining an event report that is related to the scope of repair 18. Step 510 includes combining the scope of repair 18 and the event report to define warranty parameters 36. Step 512 includes selecting building materials to define a materials list. Step 514 includes combining the scope of repair 18, materials list and the warranty parameters 36 to define an estimated material cost. Step 516 includes communicating the scope of repair 18, the materials list and the estimated material cost to a contractor bidding interface 38. Step 518 includes receiving bids from at least one bidding contractor 46 via the contractor bidding interface 38. Through the contractor bidding interface 38, various contractors can evaluate the materials provided by the user 40 and place bids that the user 40 can evaluate. Once the user 40 is able to evaluate the various bids provided by bidding contractors 46, step 520 includes selecting a desired contractor 44 from the at least one bidding contractor 46 utilizing the contractor bidding interface 38.

Referring now to FIGS. 1-9 and 12, a method 600 is disclosed for obtaining a bid for repairing a roof of a building structure 10 utilizing an aspect of the building repair program 42 and the contractor bidding interface 38. According to the method 600, step 602 includes generating a three-dimensional model 50 of the building structure 10 using aerial photographs 30 and exterior photographs 32 of the building structure 10. According to the method 600, the user 40 can utilize a portable computing device to select at least a portion of the three-dimensional model 50 to define the scope of repair 18 that corresponds to the building structure 10 (step 604). Step 606 of the method 600 includes the user 40 selecting a list of materials that relate to the scope of repair 18. Step 608 of the method 600 includes combining the scope of repair 18 and the list of materials to define a project estimate. Step 610 includes communicating the scope of repair 18, the list of materials and the project estimate to a contractor bidding interface 38. Step 612 includes receiving bids from at least one bidding contractor 46 via the contractor bidding interface 38. Step 614 includes selecting a desired contractor 44 from the at least one bidding contractor 46 via the contractor bidding interface 38. Step 616 includes communicating information related to the desired contractor 44 to a plurality of financial institutions 62 to obtain a plurality of financing offers. Step 618 includes selecting a preferred financing offer of the plurality of financing offers. In this manner, the user 40 can seek and obtain competitive bids for financing related to the scope of repair 18 for the building structure 10.

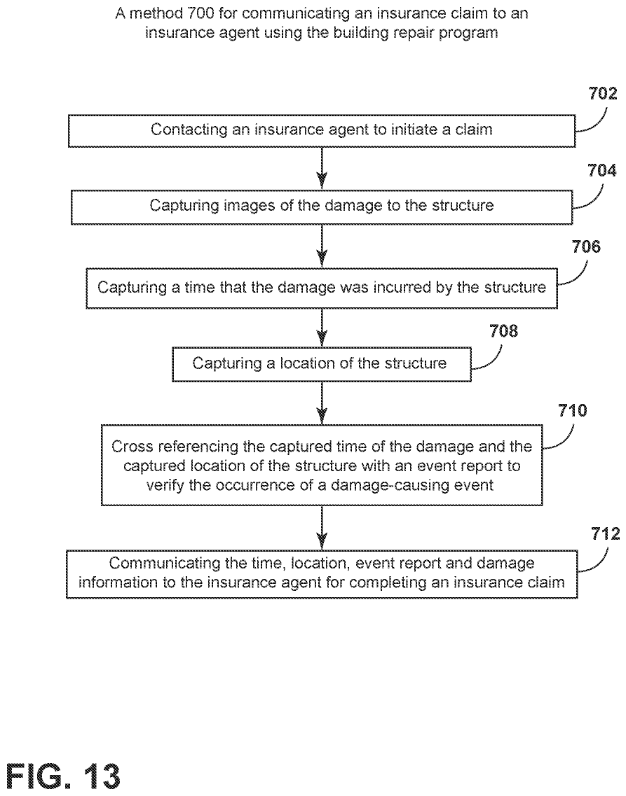

Referring now to FIG. 13, according to various aspects of the device, a method 700 is included within the building repair program 42 for communicating an insurance claim to an insurance agent 90. This method 700 is useful in defining the warranty parameters 36 of the scope of repair 18. According to the method 700, step 702 includes contacting an insurance agent 90 to initiate a claim. This is done through use of the portable computing device that operates the building repair program 42. The user's insurance agent 90, as well as other insurance agents 90, can be included within the building repair program 42, as desired by the user 40. Step 704 of the method 700 includes capturing images of the damage to the structure 10. These images reflect the nature, extent and magnitude of the damage to the structure 10 for ascertaining the scope of repair 18 and for making an insurance claim. Step 706 of the method 700 includes capturing a time that the damage was incurred by the structure 10. The location of the structure 10 is also captured within the building repair program 42 (step 708). Using the time and location that are captured using the portable computing device, this information can be cross-referenced with an event report regarding a damage causing event (step 710). This event report is typically in the form of meteorological information to verify a weather event. Other event reports can be used for making an insurance claim. Such reports can include police reports, fire reports, and other similar information related to damage to a building structure 10. The time, location, event and damage information are then delivered or uploaded, using the building repair program 42 to the insurance agent 90 for completing an insurance claim (step 712). As described herein, this method 700 can be utilized as part of the process for obtaining a group of competitive bids utilizing the building repair program 42 and the contractor bidding interface 38.

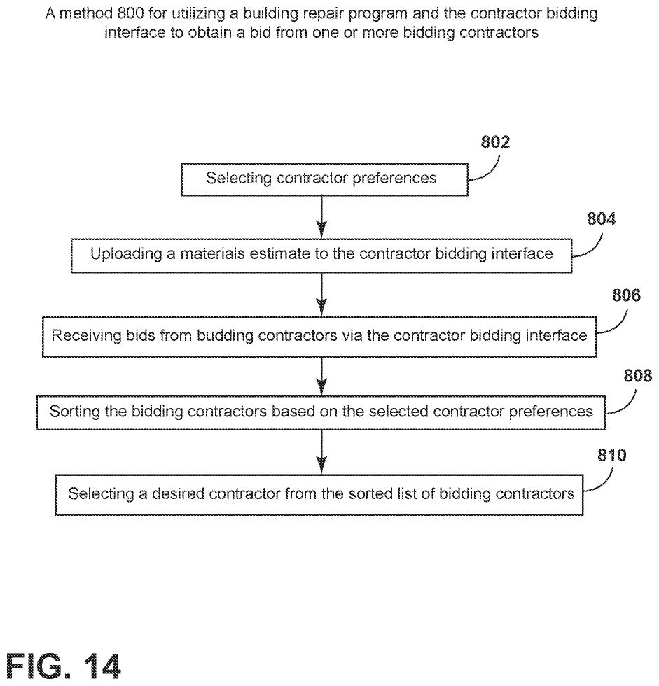

Referring now to FIG. 14, a method 800 is disclosed for utilizing the building repair program 42 and the contractor bidding interface 38 to obtain a bid from one or more bidding contractors 46. According to the method 800, preferences are selected regarding bidding contractors 46 for purposes of sorting the bids ultimately received by the user 40 (step 802). The user 40 also delivers or uploads a materials estimate to the contractor bidding interface 38 for prospective bidders to bid on (step 804). As described herein, other information related to the repair project 12 can also be provided to the contractor bidding interface 38 for obtaining competitive bids. After the information is provided to the contractor bidding interface 38, bids from bidding contractors 46 are received (step 806). These received bids are then sorted based on the contractor preferences entered by the user 40 (step 808). Based upon this sorting function and other information provided within each of the bids, the user 40 selects a desired contractor 44 (step 810).

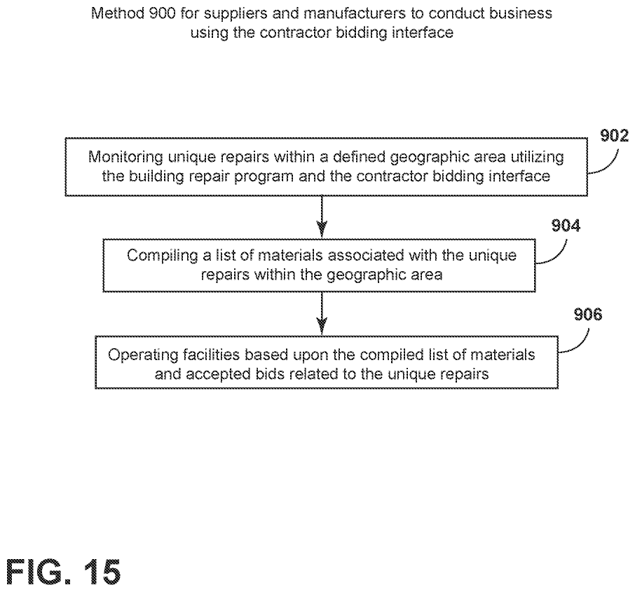

Referring now to FIG. 15, the building repair program 42 and the contractor bidding interface 38 can also be used by at least one and typically a plurality of construction materials suppliers, and construction material manufacturers for assessing the need for building materials within a particular geographic area. A method 900 is disclosed for allowing these suppliers and manufacturers to acquire information relating to the construction industry within a geographic area. According to the method 900, a step 902 includes monitoring unique repairs within a defined geographic area utilizing the building repair program 42 and the contractor bidding interface 38. This geographic area can be relatively small, such as a city parish, township or county. The geographic area can also be larger, such as several counties, one or more states or a region on of a country. Depending upon the number of bids that are accepted, suppliers and manufacturers are able to gauge the amount of building materials that will be needed within a geographic area and over a particular period of time to provide for bulk purchasing. Using the information regarding accepted bids, the suppliers and manufacturers can compile a list of materials associated with the unique repairs (step 904). Using this information, suppliers can place orders and manufacturers can operate manufacturing facilities to match the demand for construction materials based on the number of accepted bids for unique repairs (step 906).

According to the various aspects of the device, the building repair program 42 and the contractor bidding interface 38 can be operated by the user 40, contractors, insurance agents 90, financial institutions 62 and the construction supply industry for keeping track of the demand for labor and materials within a particular geographic area and over a particular period of time. Using the building repair program 42 and the contractor bidding interface 38, the infrastructure of the construction industry can be operated in an efficient manner that minimizes waste and maximizes available resources.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A method for obtaining a bid for repairing a roof of a building structure, the method comprising steps of:
obtaining, via a portable computing device, information about the building structure using aerial photographs and exterior photographs of the building structure to define a work site;
selecting, via the portable computing device, at least a portion of the work site to define a scope of repair within the work site;
obtaining, via the portable computing device, an event report related to the scope of repair;
combining, via the portable computing device, the scope of repair and the event report to define warranty parameters;
communicating, via the portable computing device, the scope of repair and the warranty parameters to a contractor bidding interface;
receiving the bids from at least one bidding contractor via the contractor bidding interface;
selecting, via the portable computing device, a desired contractor from the at least one bidding contractor, via the contractor bidding interface; and
selecting payment terms for paying the desired contractor.

2. The method of claim 1, wherein the step of selecting at least a portion of the work site includes selecting building materials to be used within the scope of repair to define a list of selected building materials.

3. The method of claim 1, wherein the step of selecting the at least a portion of the work site is conducted using the exterior photographs.

4. The method of claim 1, wherein the exterior photographs and the aerial photographs are combined together to define a three-dimensional model of the work site, wherein the scope of repair is selected from a portion of the three-dimensional model.

5. The method of claim 1, wherein the step of communicating the scope of repair and the warranty parameters to the contractor bidding interface includes communicating the scope of repair and the warranty parameters from the portable computing device to a communications hub.

6. The method of claim 5, wherein the contractor bidding interface is defined within the communications hub.

7. The method of claim 5, wherein after the desired contractor is selected, the list of selected building materials is communicated to at least one construction material supplier via the communications hub.

8. The method of claim 5, wherein after the desired contractor is selected, the list of selected building materials is communicated to at least one construction material manufacturer via the communications hub.

9. The method of claim 1, wherein the event report includes historical meteorological information regarding an area surrounding the building structure.

10. A method for obtaining a bid for repairing a portion of a building structure, the method comprising steps of:
obtaining, via a portable computing device, information about the building structure using aerial photographs and exterior photographs;
combining the aerial photographs and the exterior photographs to define a three-dimensional model of the building structure;
selecting, via the portable computing device, at least a portion of the three-dimensional model to define a scope of repair related to the building structure;
obtaining, via the portable computing device, an event report related to the scope of repair;
combining, via the portable computing device, the scope of repair and the event report to define warranty parameters;
selecting building materials to define a materials list;
combining the scope of repair, the materials list and the warranty parameters to define an estimated material cost;
communicating, via the portable computing device, the scope of repair, the materials list and the estimated material cost to a contractor bidding interface;
receiving the bids from at least one bidding contractor via the contractor bidding interface; and
selecting, via the portable computing device, a desired contractor from the at least one bidding contractor, via the contractor bidding interface.

11. The method of claim 10, wherein after the desired contractor is selected, the materials list is sent to at least one construction materials supplier.

12. The method of claim 10, wherein after the desired contractor is selected, the materials list is sent to at least one construction materials manufacturer.

13. The method of claim 10, wherein the event report includes historical meteorological information regarding an area surrounding the building structure.

14. The method of claim 10, wherein the step of communicating the scope of repair and the warranty parameters to the contractor bidding interface includes providing contractor sorting parameters.

15. The method of claim 14, wherein the step of receiving bids from the at least one bidding contractor includes listing the at least one bidding contractor according to the contractor sorting parameters.

16. A method for obtaining a bid for repairing a roof of a building structure, the method comprising steps of:
generating a three-dimensional model of the building structure using aerial photographs and exterior photographs of the building structure;
selecting at least a portion of the three-dimensional model to define a scope of repair that corresponds to the building structure;
selecting a list of materials that relate to the scope of repair;
combining the scope of repair and the list of materials to define a project estimate;
communicating the scope of repair, the list of materials and the project estimate to a contractor bidding interface;
receiving the bids from at least one bidding contractor via the contractor bidding interface;
selecting, via a portable computing device, a desired contractor from the at least one bidding contractor, via the contractor bidding interface;
communicating information related to the desired contractor to a plurality of financial institutions to obtain a plurality of financing offers; and
selecting a preferred financing offer of the plurality of financing offers.

17. The method of claim 16, wherein the step of communicating the scope of repair, the list of materials and the project estimate to the contractor bidding interface includes communicating the scope of repair, the list of materials and the project estimate from the portable computing device to a communications hub.

18. The method of claim 17, wherein the contractor bidding interface is defined within the communications hub.

19. The method of claim 17, wherein after the desired contractor is selected, the list of selected building materials is communicated to at least one construction material supplier via the communications hub.

20. The method of claim 17, wherein the communications hub is incorporated within the portable computing device.
